(19) United States
(12) Patent Application Publication
(10) Pub. No.: US 2018/0200940 A1
(43) Pub. Date: Jul. 19, 2018

(54) HOLLOW MOLD

(71) Applicant: NIHON PLAST CO., LTD., Shizuoka (JP)

(72) Inventor: Koji ISHIKAWA, Shizuoka (JP)

(21) Appl. No.: 15/866,866

(22) Filed: Jan. 10, 2018

(30) Foreign Application Priority Data
Jan. 13, 2017 (JP) 2017-003921

(51) Int. Cl. B29C 49/48; B29C 49/50

(52) U.S. Cl. CPC B29C 49/4802; B29C 2049/4805; B29C 49/50

(57) ABSTRACT

Provided is a hollow mold which can improve the manufacturing efficiency for a hollow mold including a protrusion. Ventilation duct 3 (hollow mold) includes main body part 20 including hollow part 30 therein, and protrusion 33 protruding outward from main body part 20. End surface 51 of main body part 20 and end surfaces 53 and 55 of protrusion 33 are flush with each other. A cutting operation is linearly performed along the end portion of main body part 20 to the end portion of protrusion 33 in plan view, whereby removal of burr 61 of protrusion 33 to form the end surface is efficiently performed.

### CROSS REFERENCE TO RELATED APPLICATIONS

Japanese Patent Application No. 2017-003921 filed on Jan. 13, 2017, including description, claims, drawings, and abstract the entire disclosure is incorporated herein by reference in its entirety.

### TECHNICAL FIELD

The present invention relates to a hollow mold. More specifically, the present invention relates to a hollow mold which is formed by blow molding of a resin.

### BACKGROUND ART

Conventionally, hollow molds which are formed by blow molding of a resin are publicly known (see, for example, PTL 1).

The hollow mold disclosed in PTL 1 is a defroster duct. The defroster duct is integrally formed with a main body part, and a plurality of attaching portions (protrusions) provided at the front end of the main body part. The attaching portion is formed in a rectangular shape in plan view so as to protrude forward along the surface direction of the top surface of the main body part.

### CITATION LIST

### Patent Literature

PTL 1

Japanese Patent Application Laid-Open No. 2014-108580

### SUMMARY OF INVENTION

### Technical Problem

Here, when molding the defroster duct by blow molding, it is necessary to form a portion including a burr in the attaching portion and thereafter remove the burr with a cutter by an operator for the purpose of integrally molding the main body part with the attaching portion protruding from the peripheral portion of the main body part, for example.

However, the burr of the peripheral portion of the attaching portion is removed with a cutter as follows. First, the cutter is advanced in the horizontal direction along the front end of the main body part; then, the orientation of the cutter is changed by 90° (right angle) at the root of the attaching portion so as to move the cutter forward; then, the orientation of the cutter is changed by 90° at the front end corner of the attaching portion so as to advance the cutter in the horizontal direction along the front end of the attaching portion; then, the orientation of the cutter is changed by 90° at the corner of the front end of the attaching portion so as to advance the cutter rearward; and then, the orientation of the cutter is changed by 90° at the attaching portion so as to advance the cutter along the front end of the main body part.

As described above, when the burr is cut off from the peripheral portion of the attaching portion with a cutter, the cutter is required to be moved rightward and leftward in the rectilinear movement in two-dimension, and therefore it is disadvantageously difficult to remove the burr at the peripheral portion of the attaching portion with high accuracy and high speed.

To solve the above-described problems, an object of the present invention is to provide a hollow mold which can improve the manufacturing efficiency for a hollow mold including a protrusion.

### Solution to Problem

To solve the above-described problems, a hollow mold according to the embodiment of the present invention includes: a main body part having a hollow shape; and a protrusion protruding outward from the main body part. The main body part includes an end surface, and the protrusion includes an end surface, the end surface of the main body part and the end surface of the protrusion being flush with each other.

### Advantageous Effects of Invention

In the hollow mold, the end surface of the main body part and the end surface of the protrusion are flush with each other. Accordingly, the cutting operation is performed by linearly moving the cutter along the end portion of the protrusion from the end portion of the main body part in plan view, thus improving the efficiently of the operation of removing the burr of the protrusion to form the end surface. In this manner, the manufacturing efficiency for a resin hollow mold including a protrusion is improved.

### BRIEF DESCRIPTION OF DRAWINGS

FIG. 1 is a plan view of a defroster duct, a ventilation duct and a steering hanger beam according to a first embodiment of the present invention as viewed from an upper side;

FIG. 2 is a perspective view of the ventilation duct and the steering hanger beam illustrated in FIG. 1 as viewed from an obliquely rear side;

FIG. 3 is a perspective view of the ventilation duct illustrated in FIG. 2 as viewed from an obliquely rear side;

FIG. 4 is a perspective view of a protrusion illustrated in FIG. 3 as viewed from an obliquely rear side;

FIG. 5 is a perspective view illustrating a state of the ventilation duct according to the first embodiment after removal from a metal mold;

FIG. 6 is a perspective view illustrating a state where the burr is being removed along a cutting line in the state illustrated in FIG. 5;

FIG. 7 is a side view illustrating a state where the burr is being removed along the cutting line in the state illustrated in FIG. 5;

FIG. 8 is a perspective view illustrating a protrusion according to another embodiment of the present invention; and

FIG. 9 is a perspective view illustrating a protrusion according to another embodiment of the present invention.

### DESCRIPTION OF EMBODIMENTS

An embodiment of the present invention is described in detail below with reference to the accompanying drawings.

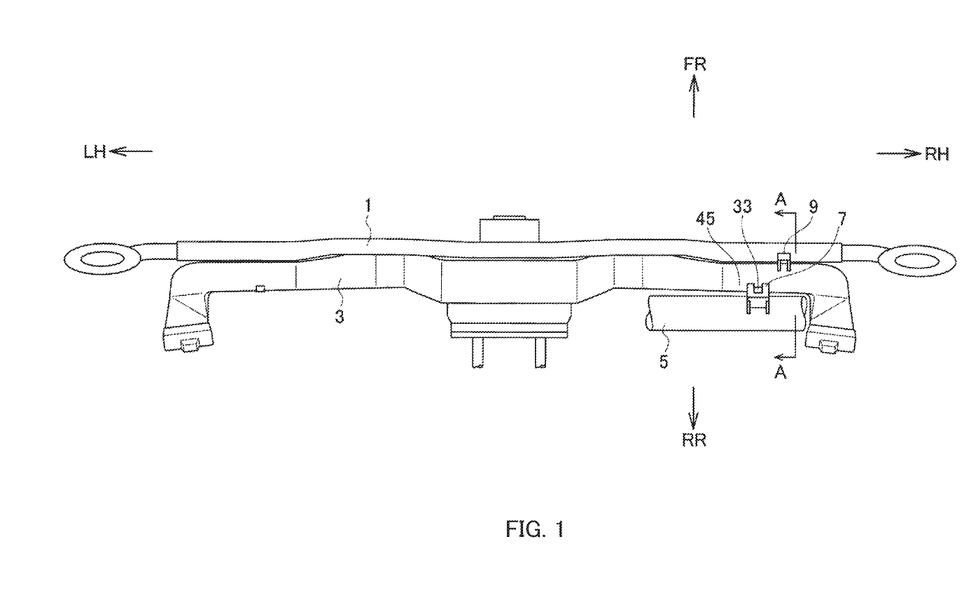

As illustrated in FIG. 1, an instrument panel not illustrated in the drawing is arranged in the front part of the interior of an automobile. Inside the instrument panel, defroster duct 1, ventilation duct 3 (hollow mold) and steering hanger beam 5, which is partially illustrated for description, extend along the horizontal direction (vehicle width direction).

Defroster duct 1 supplies, from a defroster opening of a front end portion of the top surface of the instrument panel, air-conditioning wind for removing inner fogging of a windshield and a side window glass near a side mirror not illustrated in the drawing. Ventilation duct 3 (hollow mold) is integrally blow-shaped with defroster duct 1 by use of a resin such as polypropylene. Ventilation duct 3 (hollow mold) sends and supplies air-conditioning wind that is output from a vertical surface of the instrument panel into the vehicle interior. Steering hanger beam 5 is manufactured by press forming, welding, casting and the like by use of a metal such as iron and magnesium, or by injection molding with polyamide resin added by use of glass fiber, or the like. In addition, as described later, steering hanger beam 5 includes first locking projection 7, and steering hanger beam 5 and ventilation duct 3 are coupled to each other when first locking projection 7 is locked at protrusion 33 of ventilation duct 3.

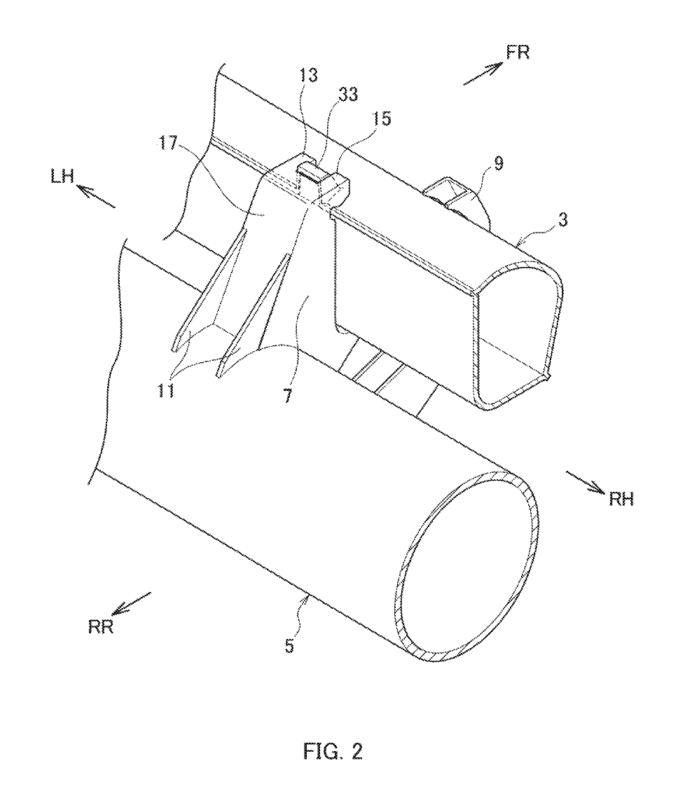

To be more specific, as illustrated in FIG. 2, second locking projection 9 and first locking projection 7 protruding forward are provided at a front part of steering hanger beam 5. First locking projection 7 extends upward from the front part of steering hanger beam 5, and is provided with a bifurcated nail part at the upper end portion thereof. That is, cutout part 15 is formed at a center portion in the horizontal direction of the upper end portion thereof, and thus bifurcated nail part 13 is formed. Protrusion 33 of ventilation duct 3 is fit in cutout part 15 of bifurcated nail part 13. In addition, second locking projection 9 holds the front surface of ventilation duct 3. First locking projection 7 and second locking projection 9 hold ventilation duct 3 in such a manner as to sandwich ventilation duct 3 from the front side and the rear side. It is to be noted that a pair of left and right ribs 11 are formed along the vertical direction on the rear surface of first locking projection 7.

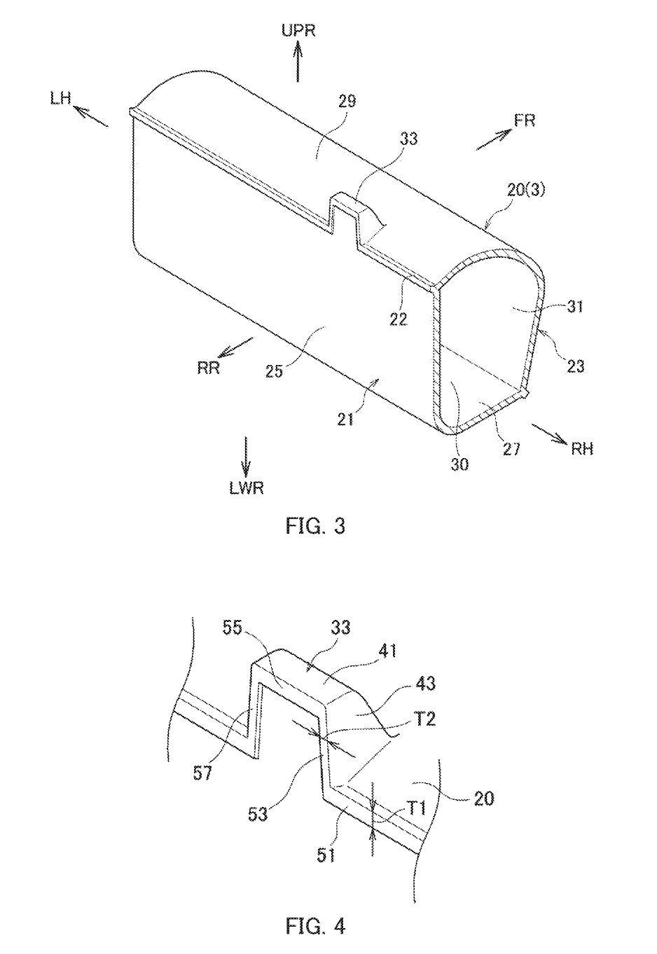

As illustrated in FIG. 3 and FIG. 4, ventilation duct 3 includes protrusion 33 in main body part 20 thereof.

In main body part 20, first resin member 21 disposed on the rear side and second resin member 23 disposed on the front side form inner hollow part 30. Specifically, a parison in the form of a tube composed of a molten resin is sandwiched with a metal mold in the blow molding, and thus the opposing parts of the parison are partially brought into contact with each other in a linear shape and coupled to each other, and then, air is jetted thereto so as to form main body part 20 having hollow part 30 therein. To be more specific, main body part 20 is formed in a closed cross sectional structure with rear surface 25 disposed on the rear side, bottom surface 27 disposed on the lower side, front surface 31 disposed on the front side, and top surface 29 disposed on the upper side. Then, the upper end portion of rear surface 25 of first resin member 21 and the front end portion of top surface 29 of second resin member 23 are joined to each other in an abutting state in the blow molding, and thus flange 22 extending obliquely upward is formed.

Protrusion 33 protrudes to the upper side, which is the direction intersecting top surface 29 of main body part 20. Protrusion 33 includes a pair of vertical wall surfaces 43 and upper bottom surface 41. Vertical wall surfaces 43 extend upward, which is the direction intersecting top surface 29 of main body part 20, and are separated from each other in the horizontal direction. Upper bottom surface 41 couples the upper ends of vertical wall surfaces 43 in the horizontal direction. End surfaces 53 and 55 of vertical wall surfaces 43 and upper bottom surface 41 are formed in a U-shape in front view. Thickness T2 of vertical wall surface 43 is smaller than thickness T1 of main body part 20. It is to be noted that end surface 51 of main body part 20 and end surfaces 53 and 55 of protrusion 33 are formed in a straight line in plan view as illustrated in FIGS. 1, 3, and 4.

Next, a procedure of removing burr 61 of flange 22 in intermediate product 103 which is removed from a metal mold after blow molding is completed is described.

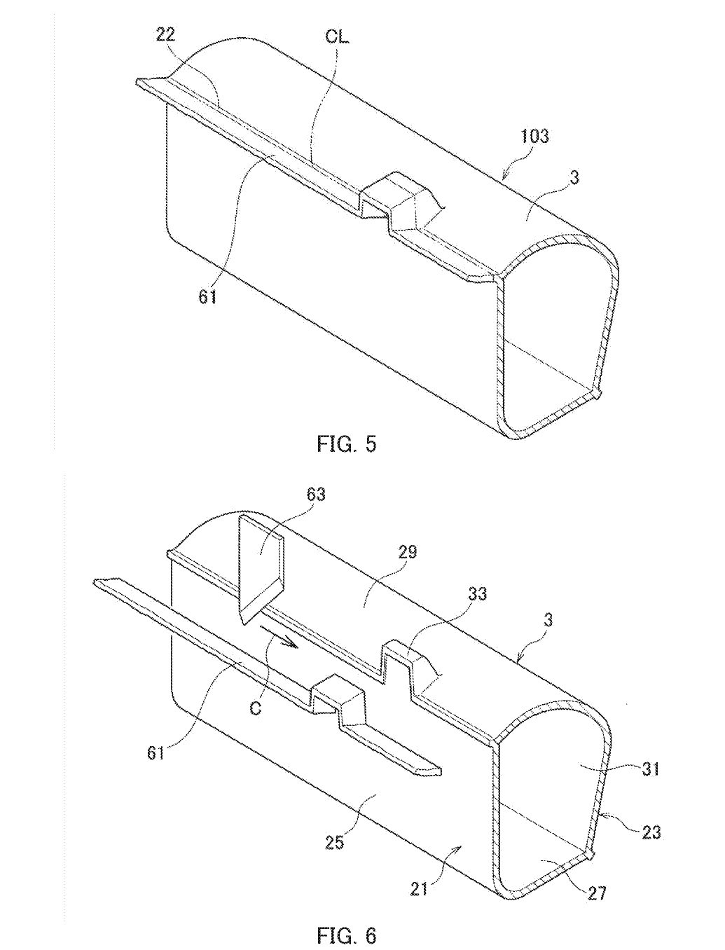

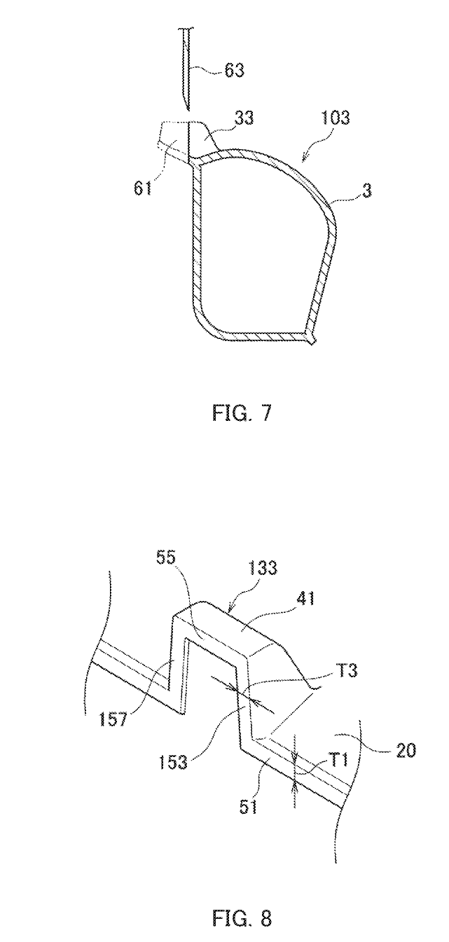

As illustrated in FIG. 5, cutting line CL, which is a virtual chain double-dashed line, is set along the longitudinal direction of flange 22 (the horizontal direction in the state where it is disposed in a vehicle). As illustrated in FIGS. 6 and 7, by linearly moving cutter 63 in the arrow C direction along cutting line CL, burr 61 can be removed.

First, by linearly moving cutter 63 along cutting line CL of flange 22 of main body part 20, the portion other than flange 22 except for protrusion 33 can be removed. Here, since protrusion 33 protrudes upward in such a manner as to intersect top surface 29 of main body part 20, cutting line CL of protrusion 33 and cutting line CL of flange 22 of main body part 20 are set as a straight line in plan view. Accordingly, when removing burr 61 of protrusion 33, burr 61 can be removed with cutter 63 without stopping cutter 63 or changing the orientation of cutter 63 as in the removal of burr 61 of flange 22 of main body part 20.

Next, the operation and the effect of the present embodiment are described below.

### (First Aspect)

Ventilation duct 3 (hollow mold) according to the present embodiment includes main body part 20 including hollow part 30 therein, and protrusion 33 provided at an end portion of main body part 20 so as to protrude in the direction intersecting top surface 29 of main body part 20. End surface 51 of main body part 20 and end surfaces 53 and 55 of protrusion 33 are formed in a straight line in plan view. Here, the “end portion” means the joining part of the resin except for flange 22 in intermediate product 103.

In this manner, in ventilation duct 3, end surface 51 of main body part 20 and end surfaces 53 and 55 of protrusion 33 are formed in a straight line in plan view. In other words, as viewed from the upper side in the UPR direction in FIG. 3, end surfaces 51, 53 and 55 form a straight line. Accordingly, in plan view, by a cutting operation of linearly moving cutter 63 along flange 22 formed from the end portion of main body part 20 to the end portion of protrusion 33, burr 61 of protrusion 33 can be removed to form end surfaces 51, 53 and 55. In view of this, the manufacturing efficiency for a resin hollow mold including protrusion 33 is improved.

That is, in the conventional hollow mold, protrusion 33 is protruded from the end portion of main body part 20 in plan view, and consequently, when removing burr 61 of the end portion of protrusion 33, it is necessary to turn cutter 63 rightward and leftward in the rectilinear movement in two dimension.

By contrast, in the present embodiment, it is not necessary to turn cutter 63 rightward or leftward in the rectilinear movement in two-dimension, and it is only necessary to linearly move cutter 63 in plan view, whereby the ease of removal of a burr is significantly increased.

### (Second Aspect)

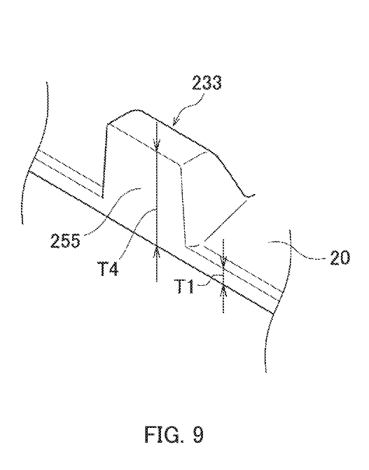

Since end surfaces 53 and 55 of protrusion 33 are formed in a U-shape in front view, the cross-sectional area of the portion removed by cutter 63 is small in comparison with the case of solid protrusion 233 (see FIG. 9). Accordingly, in the case of U-shaped protrusion 33, the difference between main body part 20 and protrusion 33 in resistance force exerted on cutter 63 in removal of burr 61 is small in comparison with the case of solid protrusion 233. Accordingly, cutter 63 can be smoothly moved from the end portion of main body part 20 to the end portion of protrusion 33.

### (Third Aspect)

Protrusion 33 includes a pair of vertical wall surfaces 43 separated from each other in the extending direction of main body part 20, and upper bottom surface 41 coupling the upper ends of vertical wall surfaces 43, and the thickness T2 of vertical wall surface 43 is smaller than thickness T1 of main body part 20.

Accordingly, the difference in the resistance force exerted on cutter 63 in removal of burr 61 between main body part 20 and protrusion 33 is further reduced. Accordingly, cutter 63 can be further smoothly moved from the end portion of main body part 20 to the end portion of protrusion 33.

### (Fourth Aspect)

In addition, the method of cutting burr 61 of ventilation duct 3 (hollow mold) according to the present embodiment is a method of cutting burr 61 integrally formed at an end portion of ventilation duct 3 made of a resin. Ventilation duct 3 includes main body part 20 including hollow part 30 therein, and protrusion 33 provided at an end portion of main body part 20 so as to protrude in the direction intersecting top surface 29 of main body part 20, and cutting line CL set at the end portion of main body part 20 and cutting line CL set at the end portion of protrusion 33 are formed in a straight line in plan view. End surfaces 53 and 55 of protrusion 33 and end surface 51 of main body part 20 are formed to be flush with each other by linearly moving cutter 63 from the end portion of main body part 20 to the end portion of protrusion 33 along cutting line CL in plan view to remove burr 61 of the end portion of protrusion 33 and flange 22 of main body part 20.

Since burr 61 of protrusion 33 can be removed by a cutting operation of linearly moving cutter 63 from the end portion of main body part 20 to the end portion of protrusion 33, the manufacturing efficiency for a hollow mold including protrusion 33 is improved.

That is, in the present embodiment, cutting line CL set at the end portion of main body part 20 and cutting line CL set at the end portion of protrusion 33 are formed in a straight line in plan view. Accordingly, it is not necessary to turn cutter 63 rightward or leftward in the rectilinear movement in two-dimension, and it is only necessary to linearly move cutter 63 in plan view, whereby the ease of removal of a burr is significantly increased.

### (Fifth Aspect)

In the method of removing burr 61 of ventilation duct 3 (hollow mold) according to the fourth aspect, the end portion of protrusion 33 is formed in a U-shape in front view.

Since the end portion of protrusion 33 is formed in a U-shape in front view as described above, the cross-sectional area of protrusions 33 and 233 removed with cutter 63 is largely different from the case of solid protrusion 233 (see FIG. 9). Accordingly, in the case of U-shaped protrusion 33, the difference in the resistance force exerted on cutter 63 in removal of burr 61 between main body part 20 and protrusion 33 between main body part 20 and protrusion 33 is small in comparison with the case of solid protrusion 233. Accordingly, cutter 63 can be smoothly moved from the end portion of main body part 20 to the end portion of protrusion 33.

### (Sixth Aspect)

In the method of removing burr 61 of ventilation duct 3 (hollow mold) according to the fifth aspect, the end portion of protrusion 33 is composed of a pair of vertical wall surfaces 43 separated from each other in the extending direction of main body part 20 and upper bottom surface 41 coupling the upper ends of vertical wall surfaces 43, and the thickness T2 of vertical wall surface 43 is smaller than thickness T1 of main body part 20.

Since thickness T2 of vertical wall surface 43 is smaller than thickness T1 of main body part 20 as described above, the difference in the resistance force exerted on cutter 63 in removal of burr 61 between main body part 20 and protrusion 33 is further reduced. Accordingly, cutter 63 can be further smoothly moved from the end portion of main body part 20 to the end portion of protrusion 33.

It is to be noted that the present invention is not limited to the above-described embodiments, and various modification may be made based on the technical ideas of the present invention.

For example, as illustrated in FIG. 8, thickness T3 of vertical wall surfaces 153 and 157 of protrusion 133 and thickness T1 of top surface 29 of main body part 20 may be equal to each other. Since thickness T3 of vertical wall surfaces 153 and 157 of protrusion 133 is greater than thickness T2 of vertical wall surface 43 of protrusion 33, the strength of protrusion 133 is greater than that of protrusion 33.

In addition, as illustrated in FIG. 9, protrusion 233 may be formed in a rectangular planar shape, not the U-shape. In this case, the height (thickness) of protrusion 233 is set to T4, and thickness T4 is greater than thickness T1. It is to be noted that height (thickness) T4 of protrusion 233 is equal to the height of protrusion 33 and protrusion 133.

### REFERENCE SIGNS LIST

3 Ventilation duct (hollow mold)
20 Main body part
30 Hollow part
33, 133, 233 Protrusion
41 Upper bottom surface
43 Vertical wall surface
51, 53, 55 End surface

1. A hollow mold comprising:
a main body part having a hollow shape; and
a protrusion protruding outward from the main body part, wherein
the main body part includes an end surface, and
the protrusion includes an end surface,
the end surface of the main body part and the end surface of the protrusion being flush with each other.

2. The hollow mold according to claim 1, wherein the end surface of the protrusion is formed in a U-shape.

3. The hollow mold according to claim 2, wherein:
the protrusion includes:
a pair of vertical wall surfaces separated from each other in an extending direction of the main body part, and
an upper bottom surface coupling upper ends of the vertical wall surfaces; and
a thickness of each of the vertical wall surfaces is smaller than a thickness of the main body part.

4. The hollow mold according to claim 1, wherein:
the main body part is made of a resin; and
the end surfaces are formed at a joining part of the resin.
